(19) United States
(12) Patent Application Publication
(10) Pub. No.: US 2014/0161427 A1
(43) Pub. Date: Jun. 12, 2014

(54) HEAT GUN

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: WU ZHOU, Shenzhen (CN); GUI-FU XIAO, Shenzhen (CN); WEI PANG, Shenzhen (CN); SONG MA, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/723,214

(22) Filed: Dec. 21, 2012

(30) Foreign Application Priority Data
Dec. 12, 2012 (CN) 201210533976.6

(51) Int. Cl. A61H 33/08

(52) U.S. Cl. CPC B23K 1/012
USPC 392/379

(57) ABSTRACT

A heat gun includes a canister, a first outlet pipe, and an assistant member. The canister includes a columnar sidewall bounding a receiving space and an installation board mounted in the receiving space. The assistant member includes a first vent pipe, and a second vent pipe communicating with the first vent pipe and slidably mounted to the first vent pipe. Top ends of the first outlet pipe and the first vent pipe extend through the installation board and communicate with an upper portion of the receiving space. Bottom ends of the first outlet pipe and the second vent pipe function as outlets of the heat gun.

### BACKGROUND

1. Technical Field

The present disclosure relates to a heat gun.

2. Description of Related Art

Heat guns are often used to blow hot air to opposite sides of chips in turn, to melt soldering tin for fixing pins at opposite sides of the chips, so that the chips can be disengaged from a motherboard easily. However, many heat guns have an outlet only to melt the soldering tins one at a time, and in case of disengaging a large chip from the motherboard, melted soldering tin at a side of the chip may have been re-solidified meanwhile the soldering tin at the other side of the chip is still being melted, which is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a heat gun.

FIG. 2 is a partly assembled, isometric view of FIG. 1.

FIG. 3 is an assembled, isometric view of FIG. 2.

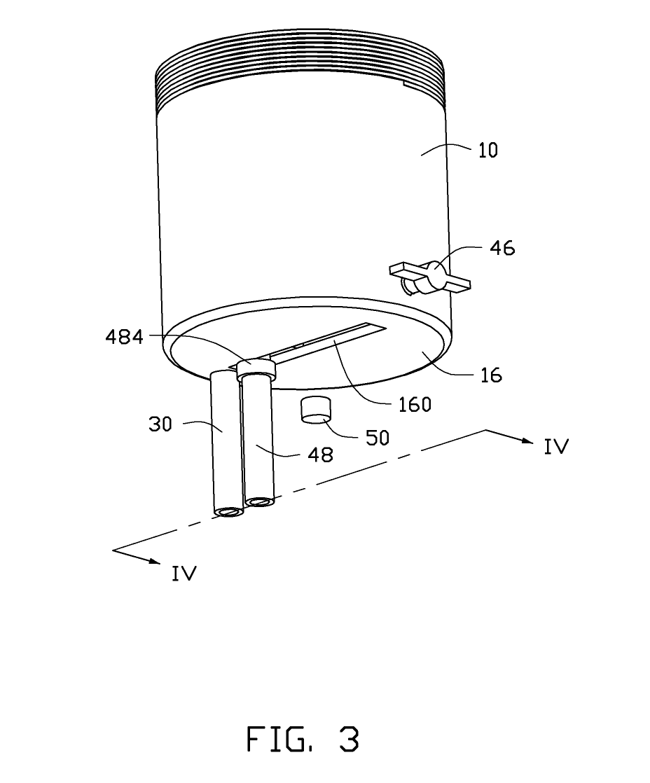

FIG. 4 is a sectional view of FIG. 3, taken along the line IV-IV.

FIG. 5 is similar to FIG. 4, but showing another using state.

FIG. 6 is similar to FIG. 3, but showing another assembled state.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

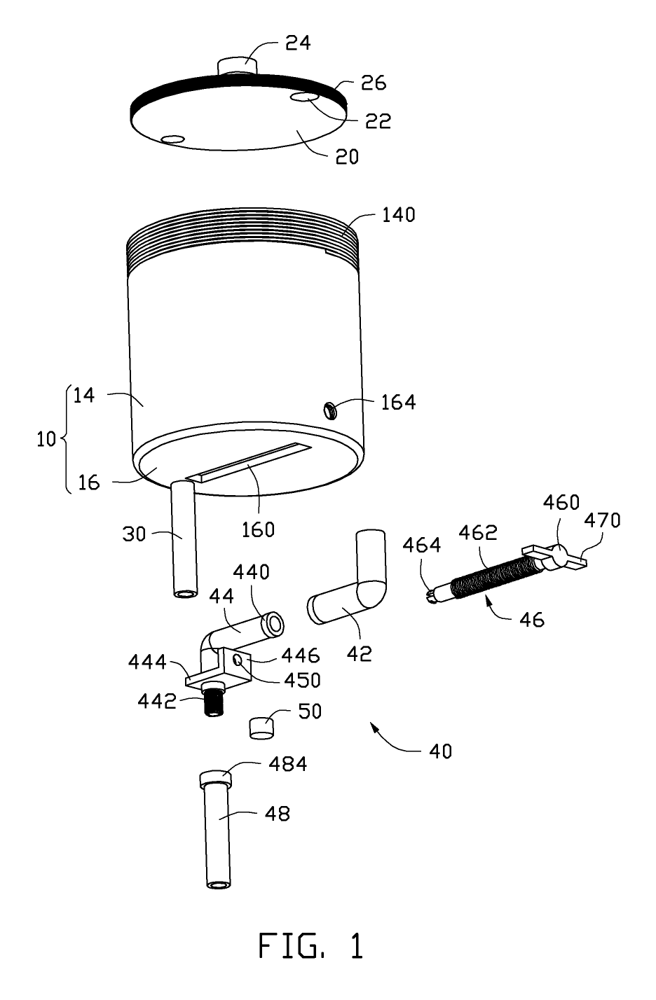

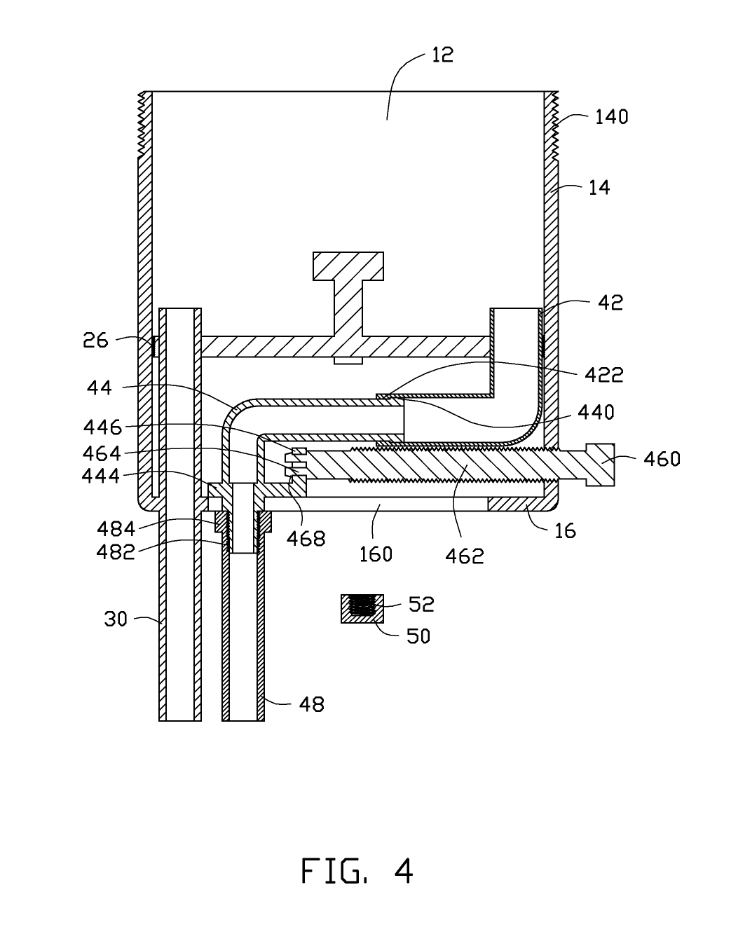

FIGS. 1 and 4 show an exemplary embodiment of a heat gun. The heat gun includes a hollow columnar canister 10, a round installation board 20, an outlet pipe 30, an assistant member 40, and a stopple 50.

The canister 10 defines a receiving space 12 extending through a top end of the canister 10. The canister 10 includes a columnar sidewall 14 bounding the receiving space 12, a cover (not shown) detachably installed to the top end of the canister 10, and a bottom wall 16 connected to and covering a bottom end of the canister 10. The bottom wall 16 defines a slot 160 in a middle of the bottom wall 16. The slot 160 communicates with the receiving space 12. The sidewall 14 defines a threaded hole 164 adjacent to an end of the slot 160. A threaded portion 140 is formed on an upper portion of an outer surface of the sidewall 14, to engage with the cover. A top end of the outlet pipe 30 extends through the bottom wall 16 to communicate with the receiving space 12. A bottom end of the outlet pipe 30 functions as a first outlet of the heat gun.

The installation board 20 defines two opposite fixing holes 22 adjacent to the edge of the installation board 20. A handle 24 is mounted to a middle of a top surface of the installation board 30 between the fixing holes 22. A threaded portion 26 is formed on a circumference of the installation board 30.

The assistant member 40 includes an L-shaped first vent pipe 42, an L-shaped second vent pipe 44, a bolt 46, and an outlet pipe 48.

An annular step 422 protrudes from a first end of an inner circumference of the first vent pipe 40.

A deformable annular protrusion 440 protrudes from a first end of an outer circumference of the second vent pipe 44. A threaded portion 442 is formed on a second end of the outer circumference of the second vent pipe 44 opposite to the protrusion 440. A block 444 protrudes from the outer circumference of the second vent pipe 44 adjacent to the threaded portion 442. A tab 446 extends from an end of the block 444 facing the protrusion 440, in a direction away from the threaded portion 442. A through hole 450 is defined in the tab 450, in a direction perpendicular to the threaded portion 442.

The bolt 46 includes a head 460, a threaded pole 462 extending from a side of the head 460, and two spaced latches 464 extending from a distal end of the threaded pole 462. A projection 468 protrudes from a side of each latch 464 opposite to the other latch 464. Two operation bars 470 extend from opposite lateral sides of the head 460.

The outlet pipe 48 forms an inner threaded portion 482 in an end of the outlet pipe 48. An annular blocking portion 484 protrudes from the outer circumference of the end of the outlet pipe 48 adjacent to the threaded portion 482.

The stopple 50 defines a threaded hole 52.

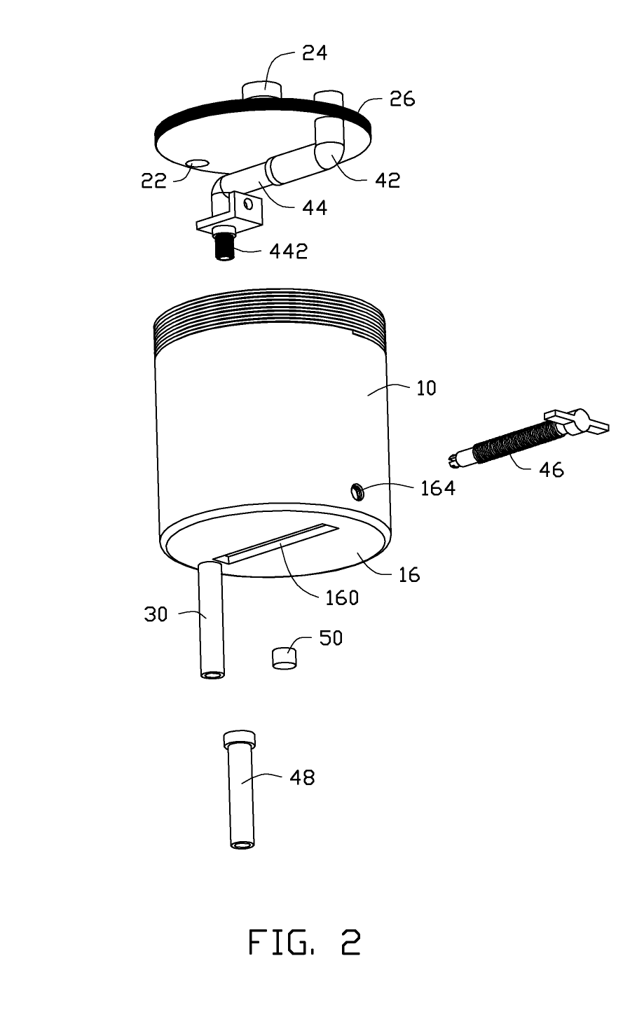

FIGS. 2 and 4 shows that in assembly, the protrusion 440 is deformed to be extended through the first end of the first vent pipe 42, and then is blocked by the step 422, thereby slidably mounting the second vent pipe 44 to the first vent pipe 42. The first and second vent pipes 42 and 44 are communicated with each other. A second end of the first vent pipe 42 away from the step 422 extends through one of the fixing holes 22 from bottom to top, to mount the second vent pipe 44 under the installation board 20 between the fixing holes 22.

The installation board 20 together with the first and second vent pipes 42 and 44 are then received in the receiving space 12. The threaded portion 26 is engaged with an inner surface of the sidewall 14, thereby fixing the installation board 20 in a lower portion of the receiving space 12. The top end of the outlet pipe 30 extends through the other fixing hole 22 of the installation board 20 and communicates with an upper portion of the receiving space 12. The second end of the second vent pipe 44 extends out of the receiving space 12 through the slot 160 to function as a second outlet of the heat gun.

The latches 464 are deformed to be extended through the threaded hole 164. The bolt 46 is rotated to move the latches 464 below the first vent pipe 42 toward the second vent pipe 44, therefore, the latches 464 are deformed to be extended through the through hole 450. After the latches 464 are restored, the projections 468 are blocked by a surface of the tab 446 facing the second vent pipe 44.

The outlet pipe 48 is engaged with the threaded portion 442 through the threaded portion 482, until the blocking portion 484 is blocked by an outer surface of the bottom wall 16. At this time, a bottom end of the outlet pipe 48 away from the bottom wall 16 functions as the second outlet of the heat gun.

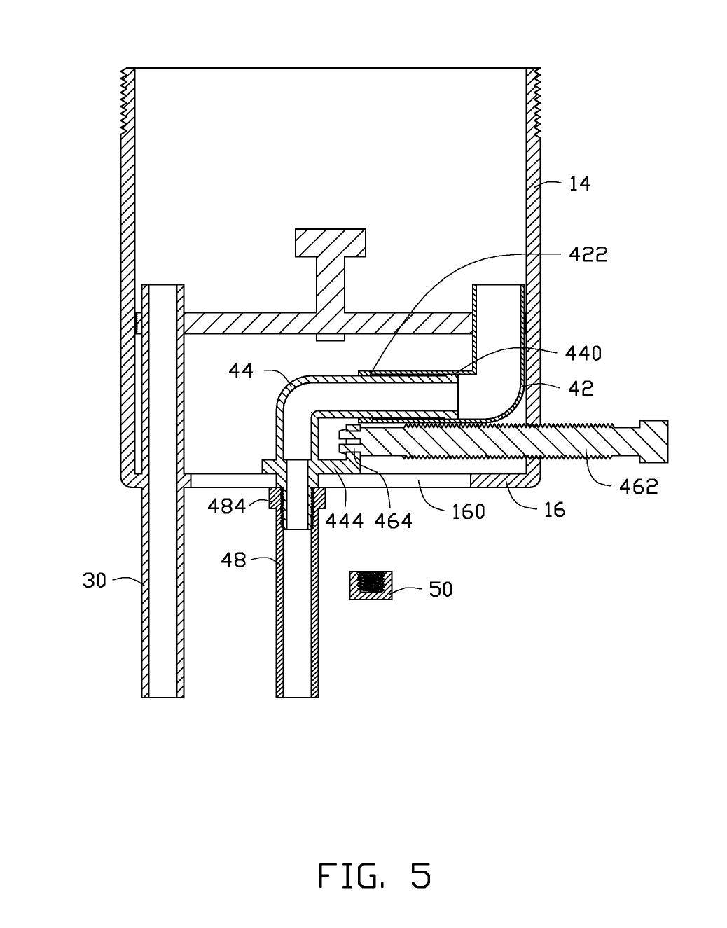

FIG. 5 shows that in use, hot airflow can flow out of the canister 10 through the bottom ends of the outlet pipes 30 and 48, toward opposite sides of a chip (not shown) at the same time. The operation bars 470 can be operated to rotate the bolt 46 outward or inward, to move the second vent pipe 44 in a direction perpendicular to the sidewall 14, to change a distance between the outlet pipe 48 and the outlet pipe 30, to fit for chips having different sizes.

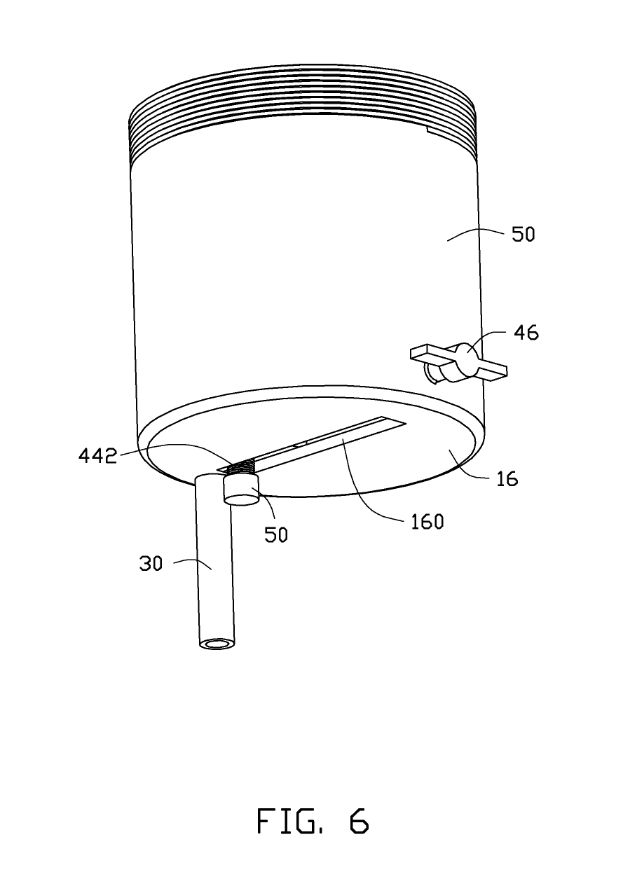

FIG. 6 shows that in case only the outlet pipe 30 is needed, the stopple 50 is engaged with the threaded portion 442 after the outlet pipe 48 is disengaged from the threaded portion 442, to prevent hot airflow from flowing out through the assistant member 40.

In another embodiment, the outlet pipe 48 can be omitted. The second end of the vent pipe 44 can be lengthened.

In another embodiment, the bottom wall 16 can be omitted.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A heat gun, comprising:
a canister defining a receiving space and comprising a columnar sidewall bounding the receiving space, and an installation board mounted in the receiving space and abutting against an inner surface of the sidewall;
a first outlet pipe; and
an assistant member comprising a first vent pipe, and a second vent pipe slidably mounted to the first vent pipe and communicating with the first vent pipe;
wherein top ends of the first vent pipe and the first outlet pipe extend through the installation board to communicate with an upper portion of the receiving space, bottom ends of the first outlet pipe and the second vent pipe away from the installation board are extended out of the canister and function as outlets of the heat gun.

2. The heat gun of claim 1, wherein the assistant member further comprises a stopple detachably mounted to the bottom end of the second vent pipe to seal the assistant member.

3. The heat gun of claim 1, wherein the installation board forms a threaded portion in a circumference of the installation board to engage with the inner surface of the sidewall.

4. The heat gun of claim 1, wherein the second vent pipe slidably mounted to the first vent pipe in a direction perpendicular to the first outlet pipe.

5. The heat gun of claim 4, wherein the first and second vent pipes are L-shaped, a step protrudes from an inner circumference of an end of the first vent pipe opposite to the installation board, a protrusion protrudes from an outer circumference of a top end of the second vent pipe, the protrusion enters the first vent pipe and is blocked by the step.

6. The heat gun of claim 5, wherein the assistant member further comprises a bolt, the sidewall defines a threaded hole communicating with the receiving space, a block protrudes from the circumference of the bottom end of the second vent pipe, a tab defining a through hole extends from an end of the block facing the threaded hole, a distal end of the bolt is capable of being rotatably extended through the through hole and blocked by the tab, the bolt is capable of being rotated to move the second vent pipe to move toward or away from the first outlet pipe.

7. The heat gun of claim 6, wherein the bolt comprises two latches formed at the distal end of the bolt, the latches are engaged in the through hole.

8. The heat gun of claim 7, wherein the bolt further comprises two projections protruding from sides of the latches away from each other to abut a side of the tab opposite to the threaded hole.

9. The heat gun of claim 1, wherein the canister further comprises a bottom wall mounted to an end of the sidewall and defining a slot communicating with a lower portion of the receiving space, the first outlet pipe extends through the bottom wall, the second vent pipe extends through the slot and is slidable along the slot.

10. The heat gun of claim 9, wherein the assistant member further comprises a second outlet pipe detachably mounted to the bottom end of the second vent pipe.

11. The heat gun of claim 9, wherein the installation board comprises a handle extending from a surface of the installation board opposite to the bottom wall.
